(19) United States
(12) Patent Application Publication
(10) Pub. No.: US 2023/0135344 A1
(43) Pub. Date: May 4, 2023

(54) URBAN AIR MOBILITY POWER SUPPLY SYSTEM AND METHOD ACCORDING THERETO

(71) Applicants: HYUNDAI MOTOR COMPANY, Seoul (KR); KIA CORPORATION, Seoul (KR)

(72) Inventor: Kyoung Joo Kim, Daejeon (KR)

(73) Assignees: HYUNDAI MOTOR COMPANY, Seoul (JP); KIA CORPORATION, Seoul (JP)

(21) Appl. No.: 17/969,216

(22) Filed: Oct. 19, 2022

(30) Foreign Application Priority Data
Nov. 1, 2021 (KR) 10-2021-0147866

(51) Int. Cl. B60L 53/18; B60L 53/36; B64C 39/02

(52) U.S. Cl. CPC B60L 53/18; B60L 53/36; B64C 39/024; B60L 2200/10; B64C 2201/066

(57) ABSTRACT

An urban air mobility (UAM) power supply system includes a UAM power supply mobility device physically connected to or disconnected from an UAM device, and a charging station including a power cable for supplying power to the UAM device. The UAM power supply mobility device is equipped with the power cable to supply the power from the charging station to the UAM device through the power cable while flying along with the UAM device until the UAM device separated from the charging station reaches an overhead position in a preset space from the charging station.

This application claims the benefit of Korean Patent Application No. 10-2021-0147866, filed on Nov. 1, 2021, which is hereby incorporated by reference as if fully set forth herein.

### TECHNICAL FIELD

The present disclosure relates to a power supply system for urban air mobility (UAM) and a method according thereto which can supply power to a UAM device by being connected to the UAM device during takeoff and stably return the UAM device to the ground by separating a power cable from the UAM device after completion of takeoff.

### BACKGROUND

Urban air mobility (UAM), a short-distance urban mobility system, is a flying means that vertically takes off from a city center, moves to a destination, and then vertically lands at the destination.

If a UAM device is powered by a battery without using a conventional fossil fuel, a large number of batteries needs to be loaded in the UAM device for taking off, landing, and operating for a long time, but battery capacity increase causes the weight of the UAM device to increase and thus more batteries need to be mounted for the heavy UAM device.

A UAM device, an electric airplane with vertical take-off and landing features that can accommodate multiple people, requires a method for increasing energy density while reducing a battery weight for efficient operation.

The UAM device consumes more energy during takeoff than during flight. When the UAM device includes a fuselage and a battery that supplies power to the UAM device, it has a considerable weight and requires tremendous energy to take off to an operational altitude (500 to 600 m).

Since the UAM device consumes a great amount of energy only to gain height in place, as described above, there is a problem that the overall flight distance is shortened.

In addition, the prior art (Korea Patent No. 10-2150856) proposes a method of supplying power to an aircraft from the ground by connecting an external cable to the aircraft. However, the technology of the prior art is not suitable for application to an aircraft that needs to be used for long-distance operation, such as a UAM device, because it relates to a device that continuously supplies power to an aircraft from the ground because the aircraft does not have its own energy source.

### SUMMARY OF THE DISCLOSURE

An object of the present disclosure is to provide an external power supply system capable of supplying power by being connected to a UAM device during takeoff and stably returning the UAM device to the ground by removing a power cable from the UAM device after completion of takeoff, and a method according thereto.

The technical problems to be achieved in the present disclosure are not limited to the technical problems mentioned above, and other technical problems that are not mentioned will be clearly understood by those skilled in the art to which the present disclosure belongs from the description below.

To achieve these objects and other advantages and in accordance with the purpose of the disclosure, as embodied and broadly described herein, an urban air mobility (UAM) power supply system includes a UAM power supply mobility device physically connected to or disconnected from a UAM device, and a charging station including a power cable for supplying power to the UAM device. The UAM power supply mobility device is equipped with the power cable to supply the power from the charging station to the UAM device through the power cable while flying along with the UAM device until the UAM device separated from the charging station reaches an overhead position in a preset space from the charging station.

In another aspect of the present disclosure, a method for supplying power to an urban air mobility (UAM) device while the UAM device is separated from a charging station and takes off includes electrically connecting a UAM power supply mobility device to the UAM device, causing the UAM power supply mobility device to fly along with the UAM device flying away from the charging station, and supplying the power to the UAM device using a power cable mounted on the UAM power supply mobility device while the UAM power supply mobility device ascends along with the UAM device until the UAM device reaches an overhead position in a preset space.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating a UAM power supply system according to an embodiment of the present disclosure;

FIG. 2 and FIG. 3 are diagrams illustrating the operation of the UAM power supply system according to an embodiment of the present disclosure;

FIG. 4 is a diagram illustrating a configuration of a UAM power supply mobility device according to an embodiment of the present disclosure;

FIG. 5 is a plan view of the UAM power supply mobility device according to an embodiment of the present disclosure;

FIG. 6 is a cross-sectional view of the UAM power supply mobility device of FIG. 5;

FIG. 7 is a plan view of a first UAM device according to an embodiment of the present disclosure;

FIG. 8 and FIG. 9 are diagrams illustrating an operation in which the UAM power supply mobility device and the first UAM device UAM1 are physically connected to each other according to an embodiment of the present disclosure;

FIG. 10 is a diagram illustrating an operation of the UAM power supply mobility device according to an embodiment of the present disclosure; and

FIG. 11 is a flowchart illustrating an operation of a power supply system for a UAM device according to an embodiment of the present disclosure.

### DETAILED DESCRIPTION OF THE DISCLOSURE

Hereinafter, embodiments of the present disclosure will be described in detail with reference to the accompanying drawings so that those of ordinary skill in the art can easily implement the same. However, the present disclosure may be implemented in various different forms and is not limited to the embodiments described herein. In order to clearly describe the present disclosure in the drawings, parts irrelevant to the description are omitted and similar reference numerals are attached to similar parts throughout the specification.

Throughout the specification, when a part “includes” a certain component, it means that other components may be further included, rather than excluding other components, unless otherwise stated. In addition, parts indicated by the same reference numerals throughout the specification mean the same components.

In addition, a unit or a control unit included in terms such as a mobility control unit (MCU) is only a term widely used in the naming of a controller that controls a specific function of an air mobility device and does not imply a generic functional unit. For example, each controller may include a communication device that communicates with other controllers or sensors to control the function of the controller, a memory that stores an operating system or logic commands, input/output information, and the like, and one or more processors that perform determination, operation, and decision necessary for controlling the function.

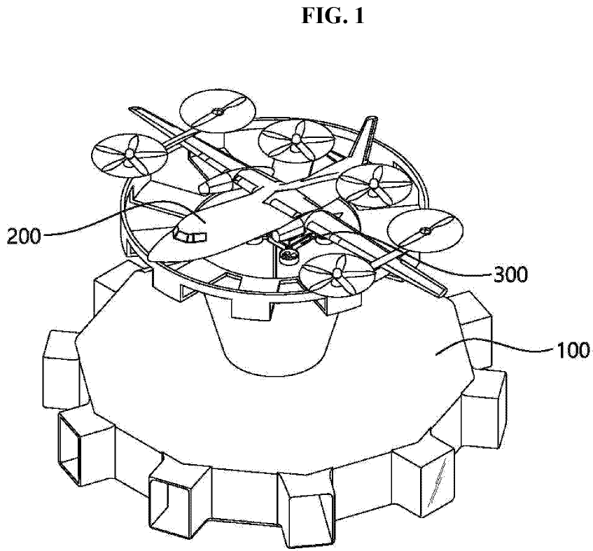

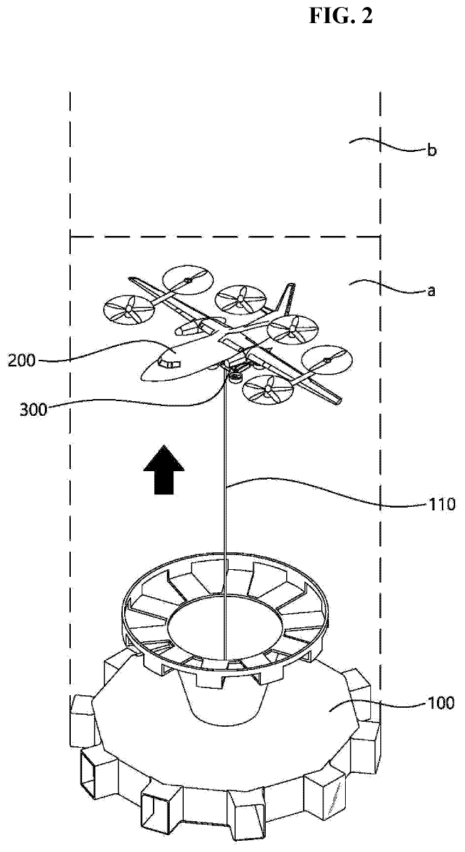

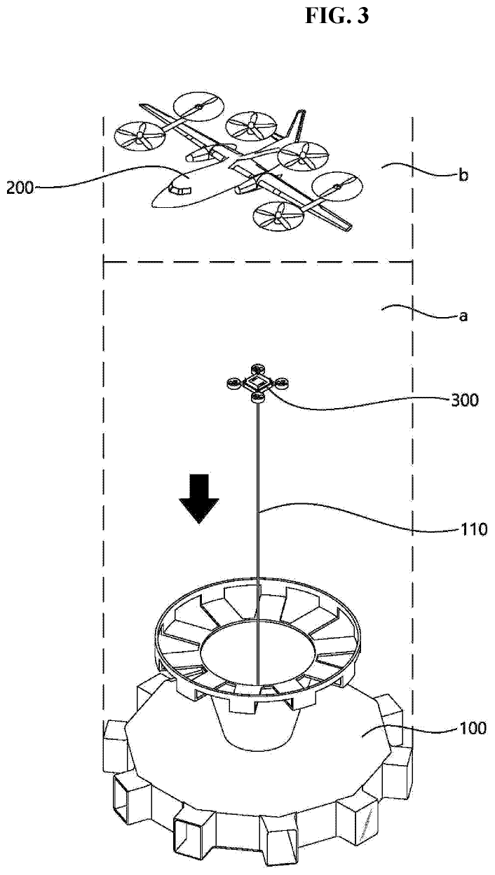

FIG. 1 is a diagram illustrating a UAM power supply system according to an embodiment of the present disclosure and FIG. 2 and FIG. 3 are diagrams illustrating an operation of the UAM power supply system according to an embodiment of the present disclosure.

Referring to FIG. 1 to FIG. 3, the UAM power supply system according to an embodiment of the present disclosure may include a first urban air mobility (UAM) device 200, a UAM power supply mobility device 300, and a charging station 100.

The first UAM device 200 may be an aircraft that can fly freely in the sky and can take off and land vertically even in a narrow space. The UAM device 200 is an urban air mobility device and can be defined as an aircraft in which an individual or a large number of passengers can freely fly in the sky in the city center. The UAM device 200 may be a concept including various manned/unmanned aerial vehicles that require vertical takeoff and landing, such as drones. The UAM device 200 may refer to a vertical takeoff and landing multicopter.

The first UAM device 200 may include one or more rotors because boarding/deboarding in the city center should be fast and comfortable. When one of the rotors provided in the first UAM device 200 malfunctions, flight balance can be controlled through the remaining rotors. That is, distributed electric propulsion (DEP) for independently driving multiple rotors may be applied to the first UAM device 200 for noise reduction and accident prevention.

DEP allows multiple rotors to be driven independently with power or electrical energy generated by a single battery. Even if an individual rotor has a problem, other rotors are continuously driven because DEP is applied to the first UAM device 200 and thus the UAM device 200 can safely fly. In addition, the first UAM device 200 uses smaller rotors than a helicopter and operates only necessary rotors depending on flight conditions such as takeoff, landing, and flying, and thus noise generation can be minimized.

In addition, distributed electric propulsion (DEP) applied to the first UAM device 200 may also be applied to the UAM power supply mobility device 300.

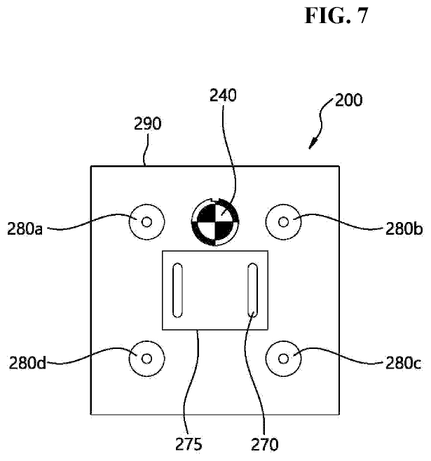

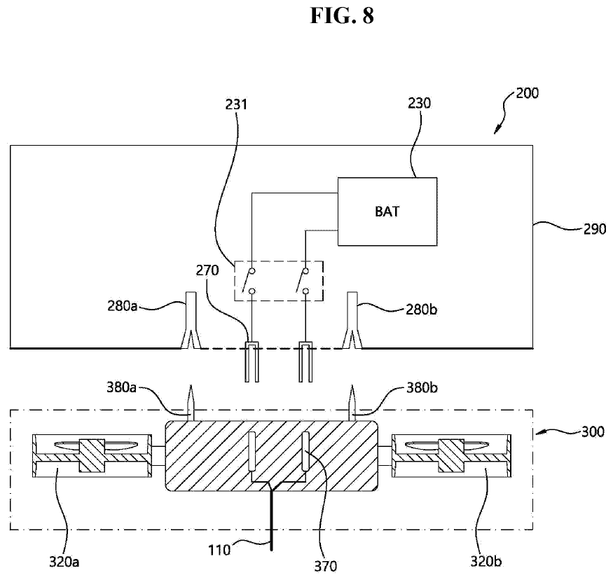

The above-described first UAM device 200 may be provided with a connection terminal 270 (refer to FIG. 7) on the bottom surface thereof. The first UAM device 200 may receive power or electrical energy through the connection terminal 270 (refer to FIG. 7), store the power or electrical energy in a battery 230 (refer to FIG. 8), individually provide the power or electrical energy stored in the battery 230 (refer to FIG. 8) to each rotor, and provide the same to various components mounted in the first UAM device 200.

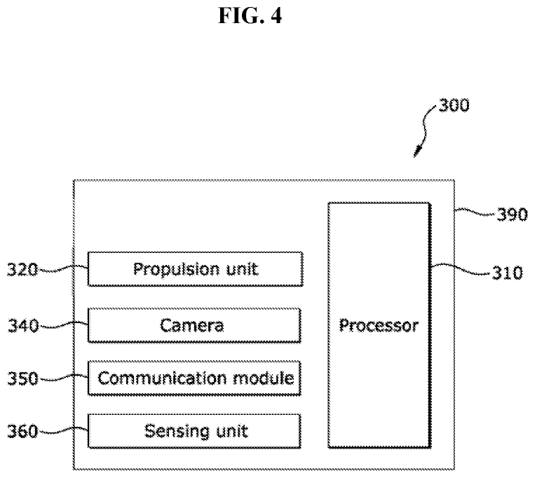

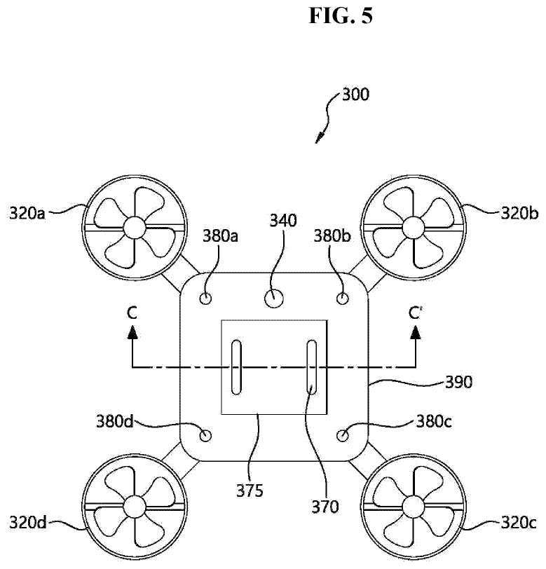

The UAM power supply mobility device 300 includes at least one rotor 320 (refer to FIG. 4) and can fly in the sky using the rotor. The UAM power supply mobility device 300 may supply power to the first UAM device 200 that is grounded or is flying using a supply terminal 370 (refer to FIG. 5) electrically and physically connected to the power cable 110. For example, the UAM power supply mobility device 300 may be disposed between the charging station 100 and the first UAM device 200 mounted or anchored in the charging station 100 and supply power to the first UAM device 200. The UAM power supply mobility device 300 may be referred to as an auxiliary power drone (APD).

Referring to FIG. 2, the UAM power supply mobility device 300 may be mounted on the first UAM device 200 flying in a preset space and supply power to the first UAM device 200 while flying with the first UAM device 200. That is, the UAM power supply mobility device 300 may be mounted on the first UAM device 200 and ascend to supply power to the first UAM device 200 until the first UAM device 200 removed from the charging station 100 reaches a position in a preset space a in the air.

Referring to FIG. 3, the UAM power supply mobility device 300 may be separated from the first UAM device 200 and descend to be mounted on the charging station 100 when the first UAM device 200 flies into a space b outside the preset space a.

The UAM power supply mobility device 300 may include the supply terminal 370 (refer to FIG. 5) electrically connected to or separated from the connection terminal 270 (refer to FIG. 7) of the first UAM device 200. The supply terminal 370 (refer to FIG. 5) may be electrically connected to the power cable 110. The UAM power supply mobility device 300 may include a fixing part (not shown) that can firmly fix the power cable 110 in order to prevent the power cable 110 from being arbitrarily detached or separated from the UAM power supply mobility device 300.

The charging station 100 is disposed on the ground and may include the power cable 110 having a predetermined length. The power cable 110 may be used to supply power to the first UAM device 200 through the supply terminal 370 (refer to FIG. 5) of the UAM power supply mobility device 300 electrically connected thereto under the control of the charging station 100.

Although not shown, the charging station 100 may include a communication module and a charging processor. The communication module may transmit information to a communication module of the UAM power supply mobility device 300 under the control of the charging processor. For example, the charging station 100 may unwind or wind a power cable 110 on the basis of position information of the UAM power supply mobility device 300 received from the UAM power supply mobility device 300.

As shown in FIG. 2, the charging station 100 may control the power cable 110 such that the power cable 110 continues to be unwound on the basis of position information and flight information of the UAM power supply mobility device 300 received from the UAM power supply mobility device 300 until the first UAM device 200 is removed from the charging station 100 and reaches a position in the preset space a in the air. Accordingly, the UAM power supply mobility device 300 may stably supply power to the first UAM device 200.

In addition, the charging station 100 may receive position information and flight information of the UAM power supply mobility device 300 in real time from the UAM power supply mobility device 300 that has been separated from the first UAM device 200 flying in the space b out of the preset space a and control the power cable 110 such that it is gradually wound on the basis of the position information and the flight information, as shown in FIG. 3. Accordingly, the UAM power supply mobility device 300 can prevent the power cable 110 from deviating from the preset space a during descending under the control of the charging station 100.

FIG. 4 is a block diagram illustrating the configuration of the UAM power supply mobility device according to an embodiment of the present disclosure.

Referring to FIG. 4, the UAM power supply mobility device 300 according to an embodiment of the present disclosure may include a processor 310, a body 390, a propulsion unit 320, a camera 340, a communication module 350, and a sensing unit 360. The present disclosure is not limited thereto, and components may be omitted or added as necessary.

The body 390 has a predetermined internal space and may be formed to a predetermined thickness. For example, the body 401 may be formed so as to have an upper surface, a lower surface, and four sides (or lateral surfaces). The present disclosure is not limited thereto and the body 401 may have any shape as long as it can firmly fasten or mount a plurality of propulsion units 320, which will be described later.

The body 390 may have the supply terminal 370 (refer to FIG. 5) disposed at a part of the upper surface. Further, the body 390 may have guide pins 380a to 380d (refer to FIG. 5) and the camera 340 (refer to FIG. 5) disposed to be spaced apart from the supply terminal 370 (refer to FIG. 5) on the upper surface. Details will be described later with reference to FIG. 5.

The propulsion unit 320 is disposed on the circumferential surface of the body 390 and may operate to cause the UAM power supply mobility device 300 to fly. The propulsion unit 320 may be referred to as a rotor. The propulsion unit 320 may operate by receiving electric energy.

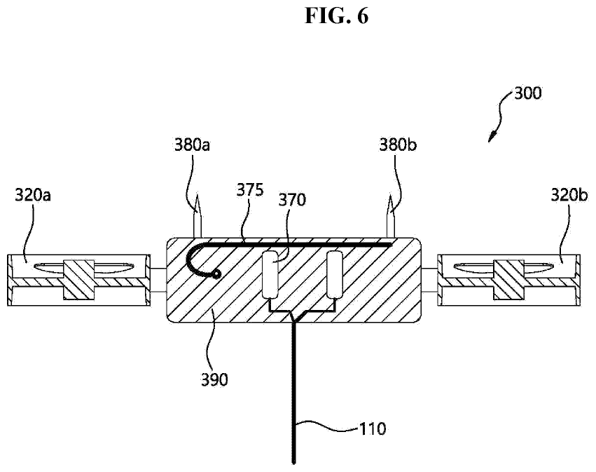

A plurality of propulsion units 320 may be provided. For example, the propulsion unit 320 includes a first rotor 320a (refer to FIG. 5), a second rotor 320b (refer to FIG. 5), a third rotor 320c (refer to FIG. 5), and a fourth rotor 320d (refer to FIG. 5). The first rotor 320a (refer to FIG. 5) to the fourth rotor 320d (refer to FIG. 5) may fly the UAM power supply mobility device 300 in the ascending or descending direction or in the forward, backward, left, and right directions under the control of the processor 310. Details will be described later with reference to FIG. 5 and FIG. 6.

The processor 310 may be disposed in the internal space of the body 390 to be electrically connected to a plurality of components mounted on the UAM power supply mobility device 300. That is, the processor 310 may control a plurality of hardware or software components electrically connected to the processor 310 by executing an operating system or an application program and perform processing/operations of various types of data including data related to the propulsion unit 320. The processor 310 may be referred to as a mobility controller (MCU) or a controller.

The processor 310 may be configured as a single integrated circuit (IC). For example, the processor 410 may include a system on chip (SoC), a graphics processing unit (GPU), or the like.

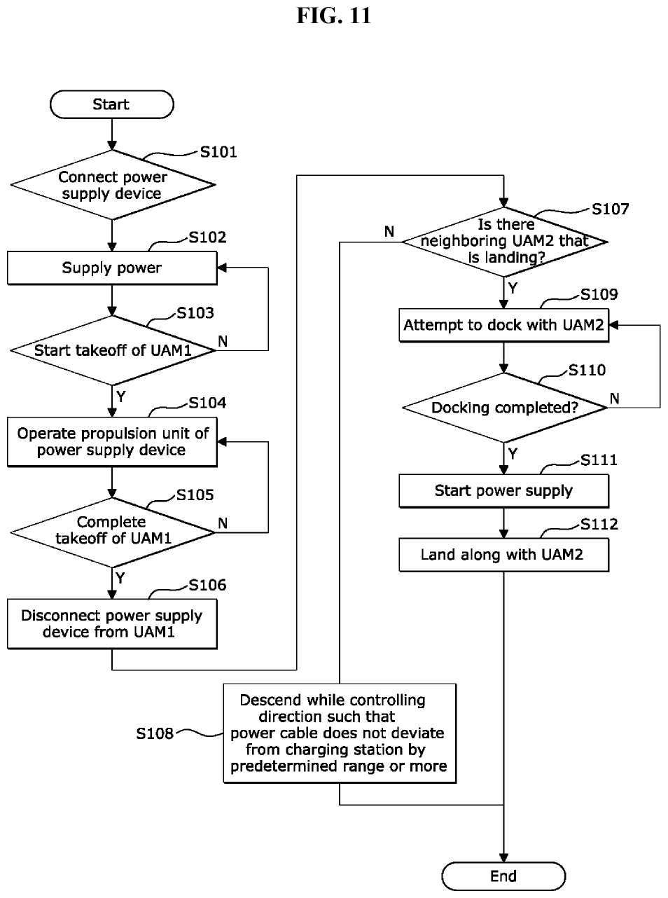

The processor 310 controls the communication module 350 to execute functions of managing data links and converting communication protocols in communication between the UAM power supply mobility device 300 and the first UAM device 200, a second UAM device UAM2 (refer to FIG. 11), the charging station 100, or another UAM power supply mobility device 300 connected through a network. The processor 310 may control data transmission/reception of the communication module 350.

The processor 310 may load a command or data received from at least one of a non-volatile memory or other components connected thereto into a volatile memory and process the same. In addition, the processor 310 may store data received from or generated by at least one of the other components in the nonvolatile memory.

The processor 310 having the above-described functions may control the propulsion unit 320 such that the UAM power supply mobility device 300 is mounted on the first UAM device 200 or the charging station 100 or separated therefrom. The processor 310 may operate by receiving power from the power cable 110 and control a plurality of components.

The camera 340 may be disposed on the upper surface of the body 390 and may capture an image of a marker 240 (refer to FIG. 7) while mounted on the first UAM device 200 under the control of the processor 310. The camera 340 may capture an image of the UAM power supply mobility device 300 and the first UAM device 200 or a second UAM device UAM2 (refer to FIG. 11) while the UAM power supply mobility device 300 is mounted on or docked with the first UAM device 200 or the second UAM device UAM2 and provide the captured image to the processor 310. The processor 310 may calculate a distance between the UAM power supply mobility device 300 and the first UAM device 200 on the basis of the captured image.

The communication module 350 may transmit flight information and position information of the UAM power supply mobility device 300 to the first UAM device 200 or the charging station 100 under the control of the processor 310. The communication module 350 may receive flight information and position information of the first UAM device 200 from the first UAM device 200 or receive position information of the charging station 100 from the charging station 100. The communication module 350 may include a wireless communication module 350 or an RF module.

The wireless communication module 350 may include Wi-Fi, BT, GPS or NFC. For example, the wireless communication module 350 may provide a wireless communication function using a radio frequency. Additionally or alternatively, the wireless communication module 350 may include a network interface, a modem, or the like for connecting the UAM power supply mobility device 300 to a network (e.g., the Internet, a LAN, a WAN, a telecommunication network, a cellular network, a satellite network, POTS, 5G network, or the like).

The RF module may serve to transmit/receive data, for example, transmit/receive RF signals or called electronic signals. For example, the RF module may include a transceiver, a power amplifier module (PAM), a frequency filter, a low noise amplifier (LNA), or the like.

The sensing unit 360 may be disposed on the body 390 to sense a position state of the UAM power supply mobility device 300. The sensing unit 360 may include at least one sensor. For example, the sensing unit 360 may include at least one of a gyro sensor, an air pressure sensor, a magnetic sensor, an acceleration sensor, a proximity sensor, a temperature/humidity sensor, and an illuminance sensor. The sensing unit 360 may sense a position or operating state of the UAM power supply mobility device 300 under the control of the processor 310 and convert measured or sensed information into an electrical signal. The sensing unit 360 may be referred to as a sensor module or a sensing module.

Although not shown in FIG. 4, the UAM power supply mobility device 300 may include a memory. The memory may include a built-in memory or an external memory. The built-in memory may include at least one of a volatile memory (e.g., dynamic RAM (DRAM), static RAM (SRAM), synchronous dynamic RAM (SDRAM), etc.) and a non-volatile memory (e.g., one-time programmable ROM (OTPROM), programmable ROM (PROM), erasable and programmable ROM (EPROM), electrically erasable and programmable ROM (EEPROM), mask ROM, flash ROM, NAND flash memory, NOR flash memory, etc.).

According to an embodiment, the built-in memory may take the form of a solid state drive (SSD). The external memory may include a flash drive, for example, compact flash (CF), secure digital (SD), micro secure digital (micro-SD), mini secure digital (mini-SD), extreme digital (xD), a memory stick, etc.

FIG. 5 is a plan view of the UAM power supply mobility device according to an embodiment of the present disclosure and FIG. 6 is a cross-sectional view of the UAM power supply mobility device of FIG. 5.

Referring to FIG. 5 and FIG. 6, the UAM power supply mobility device 300 may include the propulsion unit 320, the supply terminal 370, guide pins 380a to 380d, the camera 340, and a terminal protector 375.

A plurality of propulsion units 320 may be disposed on the circumferential surface or the sides of the body 390. Although FIG. 5 illustrates that the propulsion units 320 are disposed at corners between neighboring sides, the present disclosure is not limited thereto. The propulsion unit 320 may be referred to as a propulsion device or a rotor.

The propulsion unit 320 may include the first rotor 320a, the second rotor 320b, the third rotor 320c, and the fourth rotor 320d.

The first rotor 320a may be disposed on the left front side of the upper surface of the body 390. The second rotor 320b may be disposed on the right front side of the upper surface of the body 390. The third rotor 320c may be disposed on the right rear side of the upper surface of the body 390. The fourth rotor 320d may be disposed on the left rear side of the upper surface of the body 390.

The first rotor 320a to the fourth rotor 320d may operate individually or together under the control of the processor 310 to allow the UAM power supply mobility device 300 to fly in the ascending or descending direction or in the forward, backward, left, and right directions. For example, the first to fourth rotors 320a to 320d can push the air downward to create lift or propulsion and use the lift or propulsion to allow the UAM power supply mobility device 300 to fly.

The supply terminal 370 may be disposed at the center of the upper surface of the body 390 and may be electrically connected to or separated from the connection terminal 270 (refer to FIG. 7) which will be described later. The supply terminal 370 may be electrically connected to the power cable 110 connected to the charging station 100.

The supply terminal 370 may be formed in a bar shape having a predetermined thickness and length. The supply terminal 370 may be formed of a metal material to supply power or electrical energy to the connection terminal 270 (refer to FIG. 7).

The terminal protector 375 may be embedded in the body 390 and may be disposed on the upper surface of the body 390 such that a part thereof surrounds the supply terminal 370. The terminal protector 375 may serve to protect the supply terminal 370 from the outside. The terminal protector 375 may be formed to cover the supply terminal 370 disposed on the upper surface of the body 390. That is, the terminal protector 375 may be formed to be flexible.

The terminal protector 375 may perform an opening operation to expose the supply terminal 370 to the outside or a closing operation to protect the supply terminal 370 from the outside under the control of the processor 310. The terminal protector 375 may be referred to as a supply terminal door. A detailed description thereof will be provided later.

The guide pins 380a to 380d may be disposed on the upper surface of the body 390 and may protrude in a direction in which the UAM power supply mobility device 300 is mounted on the first UAM device 200 such that the guide pins 380a to 380d are inserted into guide pin insertion portions 280a to 280d (refer to FIG. 7) which will be described later. The guide pins 380a to 380d may be formed to protrude upward.

The guide pins 380a to 380d may be disposed on the upper surface of the body 390 such that they are not superposed on the supply terminal 370 or the terminal protector 375.

The guide pins 380a to 380d may include the first guide pin 380a to the fourth guide pin 380d.

The first guide pin 380a may be disposed on the left front side of the upper surface of the body 390. The second guide pin 380b may be disposed on the right front side of the upper surface of the body 390. The third guide pin 380c may be disposed on the right rear side of the upper surface of the body 390. The fourth guide pin 380d may be disposed on the left rear side of the upper surface of the body 390.

As described above, in the present disclosure, the first guide pin 380a to the fourth guide pin 380d are disposed on the upper surface of the body 390, and thus the UAM power supply mobility device 300 can be aligned with the first UAM device 200 or the second UAM device UAM2 (refer to FIG. 11) at a more correct position.

Although FIG. 5 illustrates four guide pins 380a to 380d, the number of guide pins 380a to 380d is not limited thereto.

The camera 340 may be disposed on the upper surface of the body 390 between the first guide pin 380a and the second guide pin 380b. The processor 310 may induce the UAM power supply mobility device 300 to be aligned with the first UAM device 200 or the second UAM device UAM2 (refer to FIG. 11) at a correct position by receiving a captured image from the camera 340.

FIG. 7 is a plan view of the first UAM device according to an embodiment of the present disclosure.

Referring to FIG. 7, the first UAM device 200 according to an embodiment of the present disclosure may include the connection terminal 270, the guide pin insertion portions 280a to 280d, and the marker 240 on the lower surface thereof facing the upper surface of the UAM power supply mobility device 300.

The connection terminal 270 may be disposed at the center of the lower surface at a position corresponding to the supply terminal 370 and electrically connected to or separated from the supply terminal 370 of the UAM power supply mobility device 300. The connection terminal 270 may be connected to the supply terminal 370 in such a manner that the supply terminal 370 is inserted thereinto.

The connection terminal 270 may be electrically connected to the battery 230 (refer to FIG. 8) built into the first UAM device 200. The connection terminal 270 may provide electric energy or power provided from the supply terminal 370 to the battery 230 (refer to FIG. 8) of the first UAM device 200. The connection terminal 270 may contain a metal material to smoothly provide electrical energy or power.

The guide pin insertion portions 280a to 280d may be disposed on the lower surface in an area other than the central region. That is, the guide pin insertion portions 280a to 280d may be disposed to be spaced apart from the connection terminal by a predetermined distance.

The guide pin insertion portions 280a to 280d may be positioned to correspond to the guide pins of the UAM power supply mobility device 300. The guide pin insertion portions 280a to 280d may include the first guide pin insertion portion 280a to the fourth guide pin insertion portion 280d. For example, the first guide pin insertion portion 280a to the fourth guide pin insertion portion 280d may be positioned to correspond to the first guide pin 380a to the fourth guide pin 380d.

The first guide pin insertion portion 280a may be disposed on the left front side of the lower surfaces of the first UAM device 200. The second guide pin insertion portion 280b may be disposed on the right front side of the lower surface of the first UAM device 200. The third guide pin insertion portion 280c may be disposed on the right rear side of the lower surface of the first UAM device 200. The fourth guide pin insertion portion 280d may be disposed on the left rear side of the lower surface of the first UAM device 200.

The marker 240 may be provided in an area other than the central region and disposed to be spaced apart from the guide pin insertion portions 208a to 280d. The marker 240 may be positioned to correspond to the camera 340 of the UAM power supply mobility device 300.

The marker 240 may be provided to be biased toward one side from the central region. Accordingly, when the marker 240 is controlled to be positioned at the center of an image captured by the camera 340 of the UAM power supply mobility device 300, the UAM power supply mobility device 300 can be caused to accurately approach the first UAM device 200.

In addition, the connection terminal protector 275 may be built into the first UAM device 200 such that a part thereof is disposed on the lower surface of the first UAM device 200 to surround the connection terminal. The connection terminal protector 275 may serve to protect the connection terminal from the outside. The connection terminal protector 275 may be formed to cover the connection terminal disposed on the lower surface of the first UAM device 200. The connection terminal protector 275 may perform an opening operation to expose the connection terminal to the outside or a closing operation to protect the supply terminal 370 from the outside under the control of the processor 310 of the first UAM device 200. A detailed description thereof will be provided later.

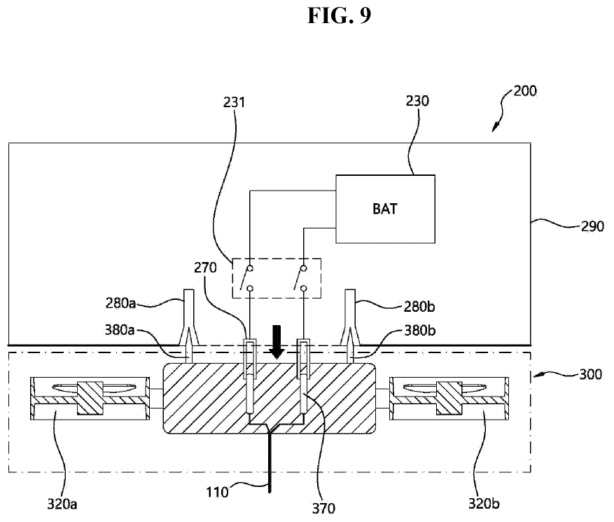

FIG. 8 and FIG. 9 are diagrams illustrating an operation in which the UAM power supply mobility device and the first UAM device are physically connected to each other according to an embodiment of the present disclosure.

Referring to FIG. 8, the UAM power supply mobility device 300 and the first UAM device 200 may approach each other to be physically connected to each other according to an embodiment of the present disclosure. That is, the UAM power supply mobility device 300 may gradually approach the first UAM device 200 to be mounted thereon. Alternatively, the first UAM device 200 may gradually approach the UAM power supply mobility device 300 to be mounted thereon.

The UAM power supply mobility device 300 and the first UAM device 200 may gradually approach each other while the communication module 350 of the UAM power supply mobility device 300 and the communication module of the first UAM device 200 transmit and receive position information and flight information of the UAM power supply mobility device 300 and the first UAM device 200.

The UAM power supply mobility device 300 may capture an image of the marker 240 of the first UAM device 200 using the camera 340. The UAM power supply mobility device 300 may approach the first UAM device 200 by controlling the propulsion unit 320 while controlling the processor 310 such that the marker 240 is disposed at the center of the captured image.

While the UAM power supply mobility device 300 and the first UAM device 200 approach each other, the terminal protector 375 of the UAM power supply mobility device 300 is gradually opened under the control of the processor 310 to expose the supply terminal 370 to the outside. In this case, the terminal protector 375 may be embedded in the UAM power supply mobility device 300 in a rollable state.

In addition, the connection terminal protector 275 of the first UAM device 200 may be gradually opened under the control of the processor 310 to expose the connection terminal to the outside.

Referring to FIG. 9, the UAM power supply mobility device 300 and the first UAM device 200 may be physically connected to each other according to an embodiment of the present disclosure. Accordingly, the guide pins 380a to 380d of the UAM power supply mobility device 300 may be inserted into the guide pin insertion portions 280a to 280d of the first UAM device 200 and the supply terminal 370 of the UAM power supply mobility device 300 may be inserted into the connection terminal 270 of the first UAM device 200.

Upon determining that the connection terminal 270 is physically connected to the supply terminal 370 of the UAM power supply mobility device 300, the first UAM device 200 may turn on a switch 231 to be provided with electric energy or power and to charge the battery 330 of the first UAM device 200.

Although not shown in FIG. 8 and FIG. 9, the UAM power supply mobility device 300 may control the supply terminal 370 to be exposed to the outside such that a part or all of the supply terminal 370 is exposed from the upper surface while the terminal protector 375 is opened. That is, the supply terminal 370 is positioned to protrude from the upper surface like the guide pins and thus can be stably inserted into the connection terminal of the first UAM device 200. Accordingly, power and electrical energy can be smoothly supplied.

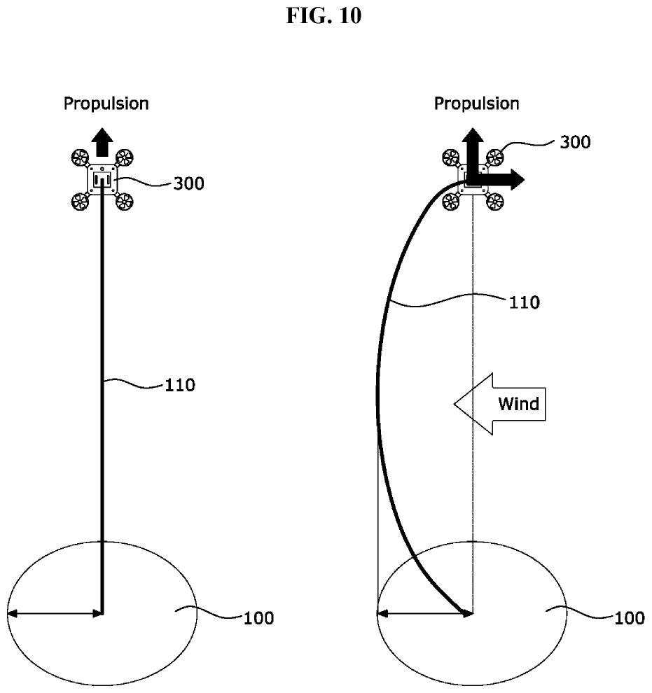

FIG. 10 is a diagram illustrating the operation of the UAM power supply mobility device according to an embodiment of the present disclosure.

Referring to FIG. 10, the UAM power supply mobility device 300 according to an embodiment of the present disclosure may ascend or descend while controlling the propulsion unit 320 such that the power cable 110 does not deviate from a preset space on the basis of a position state of the UAM power supply mobility device 300 provided by the sensing unit 360. The preset space may be a ground area where the charging station 100 is installed and an area above the charging station 100.

The processor 310 of the UAM power supply mobility device 300 may collect information about a position or operating state of the UAM power supply mobility device 300 provided by the sensing unit 360 in real time and calculate or predict a wind direction in the preset space on the basis of the collected information.

When there is no wind over the charging station 100 or the platform, the power cable 110 may be positioned vertically with respect to the charging station 100 and the UAM power supply mobility device 300. Accordingly, when the wind hardly blows, the propulsion unit 320 may generate the propulsion in the upward direction such that the UAM power supply mobility device 300 flies down under the control of the processor 310.

On the other hand, when the wind blows over the charging station 100 or the platform, the power cable 110 and the UAM power supply mobility device 300 are moved in the opposite direction to the wind. In this case, they may collide with other facilities and may interfere with a route of another UAM in a nearby charging station 100. Accordingly, when the wind blows in a first direction, the propulsion unit 320 may generate the propulsion in the upward direction and at the same time in a second direction opposite to the first direction such that the UAM power supply mobility device 300 can descend.

As described above, when the wind blows, the UAM power supply mobility device 300 may control the propulsion unit 320 such that the propulsion acts in the opposite direction to the wind to prevent the power cable 110 from deviating by a predetermined range or more.

Accordingly, the UAM power supply mobility device 300 disconnected from the first UAM device 200 can slowly descend to the charging station 100 with the power cable 110 remaining in a preset space even if the wind blows.

FIG. 11 is a flowchart illustrating the operation of the UAM power supply system according to an embodiment of the present disclosure.

Referring to FIG. 11, the UAM power supply system according to an embodiment of the present disclosure may operate as follows.

First, the UAM power supply mobility device 300 may be electrically connected to the first UAM device 200 in the charging station 100 (S101) and may provide power or electrical energy necessary for the first UAM device 200 on the ground while charging the battery 330 built into the first UAM device 200 (S102).

Then, when the first UAM device 200 starts to take off (YES in S103), the UAM power supply mobility device 300 may operate the propulsion unit 320 to take off along with the first UAM 200 (S104). That is, the UAM power supply mobility device 300 may ascend while being mounted on the first UAM device 200 to provide power to the first UAM 200 until the first UAM device 200 separated from the charging station 100 reaches an overhead position in a preset space.

Upon completion of takeoff of the first UAM device 200 (YES in S105), the UAM power supply mobility device 300 may release docking with the first UAM device 200 (S106).

Thereafter, the disconnected UAM powered mobility device 300 may slowly land on the charging station 100 from the undocked position by its own propulsion. The charging station 100 may be referred to as a helipad.

That is, when the first UAM device 200 flies out of a preset space, the UAM power supply mobility device 300 may be separated from the first UAM device 200 and descend to be mounted on the charging station 100.

If there is the second UAM device UAM2 that intends to land on the same charging station 100 when the UAM power supply mobility device 300 is about to land thereon (YES in S107), the UAM power supply mobility device 300 may attempt to dock with the second UAM device UAM2 (S109).

If there is no second UAM device UAM2 that intends to land on the same charging station 100 when the UAM power supply mobility device 300 is about to land thereon (NO in S107), the UAM power supply mobility device 300 may land alone while controlling the vertical propulsion and the horizontal propulsion such that the power cable connected to the ground does not deviate beyond a predetermined range during landing (S108).

Upon completion of docking with the second UAM device UAM2 (YES in S110), the UAM power supply mobility device 300 may land along with the second UAM device UAM2 on the charging station 100 (S112) while supplying power or electrical energy to the second UAM device UAM2 (S111).

That is, when the second UAM device UAM2 enters a preset space to be mounted on the charging station 100 after the UAM power supply mobility device 300 is separated from the first UAM device 200, the UAM power supply mobility device 300 may receive flight information and position information of the second UAM device UAM2 from the second UAM device UAM2 and fly to dock with the second UAM device UAM2 on the basis of the information. Here, the second UAM device UAM2 may receive flight information and position information of the UAM power supply mobility device 300 and fly to dock with the UAM power supply mobility device 300 on the basis of the information.

At this time, the camera 340 mounted on the UAM power supply mobility device 300 is provided to be biased to one side from the center of the UAM power supply mobility device 300 and the marker 240 disposed on the second UAM device UAM2 is also provided to be biased to one side like the camera 340, and thus the UAM power supply mobility device 300 and the second UAM device UAM2 can approach each other at a correct position while controlling the marker 240 to be positioned at the center of a camera image.

Upon docking with the second UAM device UAM2, the UAM power supply mobility device 300 may land along with the second UAM device UAM2 on the charging station 100 while supplying power to the second UAM device UAM2.

Although the first UAM device 200 and the second UAM device UAM2 have been separately described in order to clarify the description of the present disclosure in FIG. 11, the present disclosure is not limited thereto and the first UAM device 200 and the second UAM device UAM2 may be the same UAM device.

As described above, when a UAM device is anchored at the charging station 100 or the platform, the UAM power supply system according to an embodiment of the present disclosure can control the battery 300 of the anchored UAM device to be charged using the UAM power supply mobility device 300 electrically and physically connected to the UAM device.

In addition, in the UAM power supply system, the UAM power supply mobility device 300 takes off along with the UAM device to supply power to the UAM device when the UAM device takes off such that energy necessary for takeoff of the UAM device can be supplied from the outside.

The UAM device is provided with power from the outside through the UAM power supply mobility device 300 instead of using the power stored in the battery 330 during takeoff, and thus the capacity of the battery 330 mounted on the UAM device can be reduced.

Since the weight of UAM device can also decrease as the capacity of the battery 330 is reduced, the range of the UAM device can be relatively increased.

The present disclosure described above can be implemented as computer-readable code on a medium in which a program is recorded. A computer-readable medium includes all kinds of recording devices in which data readable by a computer system is stored. Examples of the computer-readable medium include a hard disk drive (HDD), a solid state drive (SSD), a silicon disk drive (SDD), a ROM, a RAM, a CD-ROM, a magnetic tape, a floppy disk, an optical data storage device, etc. When a corresponding processor (or processors) executes the program, the corresponding processor (or processors) may be configured to perform the above-described operations.

Therefore, the above detailed description should not be construed as restrictive in all respects but as exemplary. The scope of the present disclosure should be determined by reasonable interpretation of the appended claims, and all modifications within the equivalent scope of the present disclosure are included in the scope of the present disclosure.

The UAM power supply system according to at least one embodiment of the present disclosure configured as described above can receive energy necessary for takeoff of a UAM device from the outside, and thus the capacity of a battery mounted on the UAM device can be reduced and the weight of the UAM device can also be reduced, thereby maximizing the range of the UAM device.

In addition, the UAM power supply system according to at least one embodiment of the present disclosure can achieve stable system operation by preventing a power cable separated from a UAM device after completion of takeoff of the UAM device from freely falling to the ground using the UAM power supply mobility device equipped with the propulsion unit.

Furthermore, when the second UAM device attempts to land on the same charging station or platform after completion of takeoff of the first UAM device, the UAM power supply system according to at least one embodiment of the present disclosure can perform power supply and battery charging while the UAM power supply mobility device in the air docks with the second UAM device that intends to land and lands along with the second UAM device, and thus a time taken for the second UAM device to wait to charge the battery on the ground can be shortened.

Effects which may be obtained by the present disclosure are not limited to the above-described effects, and various other effects may be evidently understood by those skilled in the art to which the present disclosure pertains from the following description.

What is claimed is:

1. An urban air mobility (UAM) power supply system comprising:
a UAM power supply mobility device physically connected to or disconnected from a UAM device; and
a charging station including a power cable for supplying power to the UAM device,
wherein the UAM power supply mobility device is equipped with the power cable to supply the power from the charging station to the UAM device through the power cable while flying along with the UAM device until the UAM device separated from the charging station reaches an overhead position in a preset space from the charging station.

2. The UAM power supply system of claim 1, wherein the UAM power supply mobility device is separated from the UAM device and descends to be mounted on the charging station when the UAM device flies out of the preset space.

3. The UAM power supply system of claim 2, wherein the UAM power supply mobility device comprises:
a body;
a supply terminal disposed on an upper surface of the body;
a propulsion unit disposed on a circumferential surface of the body and configured to allow the UAM power supply mobility device to fly; and
a processor configured to control the propulsion unit such that the UAM power supply mobility device is mounted on the UAM device or the charging station or is separated from the UAM device or the charging station.

4. The UAM power supply system of claim 3, wherein the UAM device comprises:
a connection terminal disposed in a central region of a lower surface of the UAM device and electrically connected to or separated from the supply terminal;
guide pin insertion portions disposed in an area other than the central region; and
a marker provided in an area other than the central region and disposed to be spaced apart from the guide pin insertion portions.

5. The UAM power supply system of claim 4, wherein the UAM power supply mobility device further comprises:
guide pins disposed on the upper surface of the body and protruding in a direction in which the UAM power supply mobility device is mounted on the UAM device to be inserted into the guide pin insertion portions; and
a camera disposed on the upper surface of the body and configured to capture an image of the marker while the UAM power supply mobility device is mounted on the UAM device under the control of the processor.

6. The UAM power supply system of claim 5, wherein the UAM power supply mobility device includes a communication module configured to communicate with the UAM device or the charging station,
wherein the communication module transmits flight information and position information of the UAM power supply mobility device to the UAM device or the charging station and receives flight information and position information of the UAM device from the UAM device or receives position information of the charging station from the charging station under the control of the processor.

7. The UAM power supply system of claim 6, wherein the UAM power supply mobility device further includes a sensing unit disposed in the body to sense a position state of the UAM power supply mobility device.

8. The UAM power supply system of claim 7, wherein the UAM power supply mobility device includes a terminal protector to protect the supply terminal from the outside when the UAM power supply mobility device is separated from the UAM device.

9. The UAM power supply system of claim 7, wherein the UAM power supply mobility device flies down while controlling the propulsion unit such that the power cable does not deviate from the preset space on the basis of the position state of the UAM power supply mobility device provided by the sensing unit.

10. The UAM power supply system of claim 7, wherein, when the UAM device enters the preset space to arrive at the charging station after an operation, the UAM power supply mobility device receives the flight information and position information of the UAM device from the UAM device and flies to dock with the UAM device on the basis of the flight information and position information.

11. The UAM power supply system of claim 10, wherein the UAM power supply mobility device is configured to control supplying the power to the UAM device upon docking with the UAM device.

12. The UAM power supply system of claim 8, wherein the charging station unwinds or winds the power cable on the basis of the received position information of the UAM power supply mobility device.

13. A method for supplying power to an urban air mobility (UAM) device while the UAM device is separated from a charging station and takes off, the method comprising:
electrically connecting a UAM power supply mobility device to the UAM device;
causing the UAM power supply mobility device to fly along with the UAM device flying away from the charging station; and
supplying the power to the UAM device using a power cable mounted on the UAM power supply mobility device while the UAM power supply mobility device ascends along with the UAM device until the UAM device reaches an overhead position in a preset space.

14. The method of claim 13, further comprising:
separating the UAM power supply mobility device from the UAM device when the UAM device flies out of the preset space; and
controlling the separated UAM power supply mobility device to descend to be mounted on the charging station.

15. The method of claim 14, wherein the controlling of the UAM power supply mobility device to descend comprises:
transmitting flight information and position information of the UAM power supply mobility device to the charging station; and
receiving position information of the charging station from the charging station.

16. The method of claim 14, wherein the controlling of the UAM power supply mobility device to descend comprises:
receiving flight information and position information of the UAM device from the UAM device when the UAM device enters the preset space to arrive at the charging station; and
controlling flight of the UAM power supply mobility device such that the UAM power supply mobility device docks with the UAM device on the basis of the received flight information and position information.

17. The method of claim 16, further comprising supplying the power to the UAM device using the power cable upon docking of the UAM power supply mobility device with the UAM device.

18. The method of claim 14, wherein the controlling of the UAM power supply mobility device to descend comprises unwinding or winding the power cable by the charging station on the basis of received position information of the UAM power supply mobility device.
